(19) United States
(12) Patent Application Publication
(10) Pub. No.: US 2025/0293818 A1
(43) Pub. Date: Sep. 18, 2025

(54) SCHEDULING MECHANISM FOR MULTIPLE COMPONENT CARRIERS

(71) Applicant: ZTE Corporation, Shenzhen (CN)

(72) Inventors: Xingguang WEI, Shenzhen (CN); Bo DAI, Shenzhen (CN); Jing SHI, Shenzhen (CN); Xianghui HAN, Shenzhen (CN); Wei GOU, Shenzhen (CN)

(73) Assignee: ZTE Corporation, Shenzhen (CN)

(21) Appl. No.: 19/222,416

(22) Filed: May 29, 2025

Related U.S. Application Data
(63) Continuation of application No. PCT/CN2023/074461, filed on Feb. 3, 2023.

(51) Int. Cl. H04L 5/00; H04W 72/12; H04W 72/231; H04W 76/20

(52) U.S. Cl. CPC H04L 5/001; H04W 72/12; H04W 72/231; H04W 76/20

(57) ABSTRACT

A mechanism for scheduling multiple component carriers within the wireless cellular access network is disclosed, including using multiple Component Carriers (CCs) to schedule channel or signal on themselves or other CCs to provide a flexible mechanism for scheduling channel or signal across the multiple CCs. A method may include configuring M CCs for a wireless terminal device, where M is an integer number larger than 1. A first scheduling command transmitted on an i^{th} CC of the M CCs schedules channel or signal on the i^{th} CC or on at least one of Nᵢ other CCs of the M CCs, where Nᵢ is an integer number larger than 0 and smaller than M, and where i is an integer number and 1≤i≤M, wherein a channel or signal on the i^{th} CC is scheduled by a second scheduling command transmitted on the i^{th} CC or on at least one of Pᵢ other CCs of the M CCs, where Pᵢ is an integer larger than 0 and smaller than M, and wherein each scheduling command schedules channel or signal on one or more CCs of the M CCs. By this, scheduling flexibility is increased, resulting in reducing scheduling delay and increasing resource utilization efficiency.

### TECHNICAL FIELD

This disclosure generally relates to resource scheduling in a wireless cellular access network and is specifically directed to a mechanism for scheduling multiple component carriers within the wireless cellular access network.

### BACKGROUND

In a cellular network, wireless communication resources for a wireless terminal device to receive or transmit data or control information may be scheduled by a base station using, for example, downlink control information (DCI). Currently, three different known scheduling mechanisms are commonly used: self-scheduling, cross-carrier scheduling, and SCell (Secondary Cell) scheduling PCell (Primary Cell). However, these known scheduling mechanisms limit the scheduling flexibility.

### SUMMARY

This disclosure relates to resource scheduling/signaling in a wireless cellular access network and is specifically directed to a mechanism for scheduling multiple component carriers within the wireless cellular access network. The various example embodiments are particularly directed to using multiple Component Carriers (CCs) to schedule channel or signal on themselves or other CCs to provide a flexible mechanism for scheduling channel or signal across the multiple CCs.

In some exemplary implementations, a method performed by a wireless access node for scheduling for multiple component carriers (CCs) is disclosed. The method may include configuring M CCs for a wireless terminal device, where M is an integer number larger than 1. Similarly, a method performed by a wireless terminal device for scheduling for multiple CCs is also disclosed, which may include receiving, from the wireless access node, the configuration of M CCs for the wireless terminal device. In various examples, a first scheduling command transmitted on an i^{th} CC of the M CCs schedules channel or signal on the i^{th} CC or on at least one of Nᵢ other CCs of the M CCs, where Nᵢ is an integer number larger than 0 and smaller than M, and where i is an integer number and 1≤i≤M, wherein a channel or signal on the i^{th} CC is scheduled by a second scheduling command transmitted on the i^{th} CC or on at least one of Pᵢ other CCs of the M CCs, where Pᵢ is an integer larger than 0 and smaller than M, and wherein each scheduling command schedules channel or signal on one or more CCs of the M CCs. In some implementations, Nᵢ is equal to M−1, and/or Pᵢ is equal to M−1. Also, an individual CC of the M CCs may include at least one of a downlink carrier or an uplink carrier.

In some exemplary implementations, which may be combined with any of the other exemplary implementations disclosed herein, the method also includes the wireless access node indicating to the wireless terminal device to enable scheduling for the M CCs, and indicating the M CCs for which scheduling is enabled. In some implementations, the method may include the wireless access node indicating M CC indexes corresponding to the M CCs and corresponding scheduling CCs for the M CCs, wherein, in order to schedule channel or signal on each one of the M CCs, a scheduling command is transmitted on the CC itself or on a corresponding scheduling CC for the CC. Similarly, the method may include the wireless terminal device receiving any of these indications from the wireless access node.

In some exemplary implementations, which may be combined with any of the other exemplary implementations disclosed herein, the method also includes the wireless access node configuring a k^{th} CC of the M CCs as a scheduling CC for a (k+1)^{th} CC of the M CCs, where k is an integer and 1≤k≤M−1, and configuring an M^{th} CC of the M CCs as a scheduling CC for a first CC of the M CCs, wherein, in order to schedule channel or signal on each one of the M CCs, a scheduling command is transmitted on the CC itself or on a corresponding scheduling CC for the CC. Similarly, the method may include the wireless terminal device receiving any of these configurations from the wireless access node.

In some exemplary implementations, which may be combined with any of the other exemplary implementations disclosed herein, the method also includes the wireless access node configuring a same search space index for a search space for the i^{th} CC and the Nᵢ other CCs of the M CCs, wherein the first scheduling command is carried in a PDCCH candidate associated with the search space with the same search space index. In some implementations, the method may include the wireless access node indicating to the wireless terminal device one or more search spaces for the i^{th} CC, wherein each of the one or more search spaces is associated with one or more CCs of the M CCs, and wherein the first scheduling command carried in a PDCCH candidate associated with the one or more search spaces schedules channel or signal on the one or more CCs associated with the search space. In some implementations, the method may also include the wireless access node indicating to the wireless terminal device a search space configuration for the one or more search spaces including at least one of the following: an associated control resource set used to configure a time/frequency control resource set in which to search for downlink control information, time location of the one or more search spaces configured by periodicity and starting offset within the periodicity, or a number of PDCCH candidates, wherein the wireless terminal device monitors the PDCCH candidates on the i^{th} CC following the search space configuration for the i^{th} CC. Similarly, the method may include the wireless terminal device receiving any of these configurations and/or indications from the wireless access node.

In some exemplary implementations, which may be combined with any of the other exemplary implementations disclosed herein, the first scheduling command may be transmitted on the i^{th} CC of the M CCs with Subcarrier Spacing (SCS) configuration u, wherein a maximum number of monitored PDCCH candidates for the wireless terminal device per slot or per span for operation with Nᵢ+1 CCs is defined as Mᵤ, where Mᵤ is an integer larger than 0, and wherein the Nᵢ+1 CCs include the i^{th} CC and the Nᵢ other CCs of the M CCs.

In some exemplary implementations, which may be combined with any of the other exemplary implementations disclosed herein, the method also includes the wireless access node indicating Pᵢ parameters (a₁, a₂, . . . , a_{P}_{ᵢ}) to the wireless terminal device to split a monitored PDCCH candidates budget for the second scheduling command for Pᵢ+1 CCs, where 0≤aₖ≤1, 0≤a₁+ . . . +aₖ+ . . . a_{P}_{ᵢ}≤1, and k is an integer where 1≤k≤Pᵢ, wherein the Pᵢ+1 CCs include the i^{th} CC and the Pᵢ other CCs of the M CCs, wherein a maximum number of monitored PDCCH candidates for the wireless terminal device per slot or per span for operation with a k^{th} CC of the M CCs is defined as Mₖ=aₖ·Mᵤ, and the maximum number of monitored PDCCH candidates for the wireless terminal device per slot or per span for operation with a (P+1)^{th} CC of the M CCs is defined as M_{P+1}=Mᵤ−ΣᵢMᵢ, wherein Mᵤ is the monitored PDCCH candidates budget for the i^{th} CC. Similarly, the method may include the wireless terminal device receiving these indications from the wireless access node.

In some exemplary implementations, which may be combined with any of the other exemplary implementations disclosed herein, the first scheduling command may be transmitted on the i^{th} CC with Subcarrier Spacing (SCS) configuration u, wherein a maximum number of monitored non-overlapped Control Channel Elements (CCEs) candidates for the wireless terminal device per slot or per span for operation with Nᵢ+1 CCs is defined as Cᵤ, where Cᵤ is an integer larger than 0, and wherein the Nᵢ+1 CCs include the i^{th} CC and the Nᵢ other CCs of the M CCs.

In some exemplary implementations, which may be combined with any of the other exemplary implementations disclosed herein, the method also includes the wireless access node indicating Pᵢ parameters (a₁, a₂, . . . , a_{P}_{ᵢ}) to the wireless terminal device to split a non-overlapped CCE budget for the second scheduling command for Pᵢ+1 CCs, where 0≤aₖ≤1, 0≤a₁+ . . . +aₖ+ . . . +a_{P}_{ᵢ}≤1, and k is an integer where 1≤k≤Pᵢ, wherein the Pᵢ+1 CCs include the i^{th} CC and the Pᵢ other CCs of the M CCs, wherein a maximum number of non-overlapped CCEs for the wireless terminal device per slot or per span for operation with a k^{th} CC of the M CCs is defined as Cₖ=aₖ·Cᵤ, and the maximum number of non-overlapped CCEs for the wireless terminal device per slot or per span for operation with a (P+1)^{th} CC of the M CCs is defined as M_{P+1}=Cᵤ−ΣₖCₖ, and wherein Cᵤ is the non-overlapped CCEs budget for the i^{th} CC. Similarly, the method may include the wireless terminal device receiving these indications from the wireless access node.

In some exemplary implementations, which may be combined with any of the other exemplary implementations disclosed herein, Control Channel Element (CCE) indexes for PDCCH candidates are determined based on a unified CC index, wherein the unified CC index is a CC index of a CC carrying a PDCCH, a CC index configured by Radio Resource Configuration (RRC) signaling, or a smallest CC index among a set of CCs that can be scheduled by the PDCCH monitored in the scheduling CC. In some exemplary implementations Downlink Control Information (DCIs) with a same DCI format carried by the first scheduling command on the i^{th} CC are padded with zeros or ones at the end of each DCI to match a DCI bit length corresponding to a maximum DCI bit size of the DCI carried by the first scheduling command on the i^{th} CC.

In some exemplary implementations, which may be combined with any of the other exemplary implementations disclosed herein, a reference Subcarrier Spacing (SCS) configuration u is defined according to one of the following: the reference SCS configuration u is configured by Radio Resource Configuration (RRC) signaling; a smallest SCS configuration u among all the M CCs is determined as the reference SCS configuration u; a largest SCS configuration u among all the M CCs is determined as the reference SCS configuration u; among all the M CCs configured, a SCS configuration of a CC in PCell is determined as the reference SCS configuration u; or among all the M CCs configured to the UE, a SCS configuration of a CC with a smallest CC index is determined as the reference SCS configuration u. In some exemplary implementations, within a time duration of each slot of the reference SCS configuration u, only up to one CC is configured with PDCCH monitoring occasions. In some exemplary implementations, the wireless terminal device is configured to monitor PDCCH on only up to X CCs with a smaller CC index of the M CCs, within a time duration of each slot of the reference SCS configuration u, where X is an integer number based on a capability of the wireless terminal device, and where 1≤X≤M.

In some exemplary implementations, which may be combined with any of the other exemplary implementations disclosed herein, the method also includes the wireless access node indicating a periodic PDCCH monitoring pattern to the wireless terminal device which dictates a CC to monitor PDCCH based on the periodic PDCCH monitoring pattern, wherein the periodic PDCCH monitoring pattern is indicated by a bit sequence with X bits, wherein X is an integer larger than 1, wherein each ┌log 2(M)┐ bits of the periodic PDCCH monitoring pattern corresponds to a slot for a reference Subcarrier Spacing (SCS) configuration, and wherein a value of each ┌log 2(M)┐ bits of the periodic PDCCH monitoring pattern indicates a target CC on which the wireless terminal device needs to monitor PDCCH. Similarly, the method may include the wireless terminal device receiving these indications from the wireless access node.

In some other implementations, an apparatus for wireless communication such as a network device is disclosed. The network device main include one or more processors and one or more memories, wherein the one or more processors are configured to read computer code from the one or more memories to implement any one of the methods above. The apparatus for wireless communication may be the wireless access node or the wireless terminal device.

In yet some other implementations, a computer program product is disclosed. The computer program product may include a non-transitory computer-readable medium with computer code stored thereupon, the computer code, when executed by one or more processors, causing the one or more processors to implement any one of the methods above.

The above embodiments and other aspects and alternatives of their implementations are explained in greater detail in the drawings, the descriptions, and the claims below.

### BRIEF DESCRIPTION OF THE DRAWINGS

FIG. 1 shows a wireless access network with an exemplary uplink, downlink, and control channel configuration.

FIG. 2 shows various example processing components of the wireless terminal device and the wireless access network node of FIG. 1.

FIGS. 3A, 3B, and 3C show example operations of known scheduling mechanisms.

FIGS. 4A, 4B, and 4C show example scheduling configurations in accordance with the new scheduling mechanism as disclosed in various embodiments herein.

FIG. 5 shows example operations of the new scheduling mechanism in accordance with various embodiments.

FIG. 6 shows additional example operations of the new scheduling mechanism in accordance with various embodiments.

### DETAILED DESCRIPTION

The technology and examples of implementations and/or embodiments described in this disclosure can be used to facilitate over-the-air radio resource allocation, configuration, and signaling in wireless access networks. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed to resource scheduling/signaling in a wireless cellular access and is specifically directed to a mechanism for scheduling multiple component carriers within the wireless cellular access network for a User Equipment (UE) by a wireless base station. The various example embodiments provide configurations and signaling to enable a Component Carrier (CC) to schedule channel or signal on itself or on another CC, and to allow channel or signal to be scheduled on the CC by itself or by a different CC. In this manner, some or all of the CCs can schedule channel or signal on some or all of the other CCs. As such, flexibility is greatly increased, which also can result in a reduction in scheduling delay and an increase in resource utilization efficiency.

### Wireless Network Overview

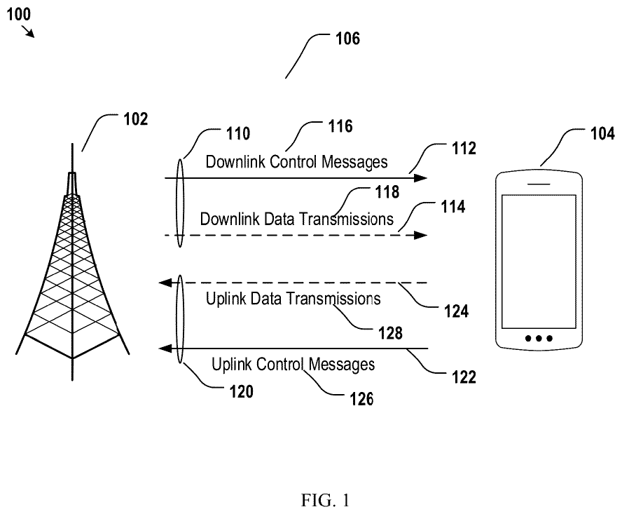

A wireless communication network may include a radio access network for providing network access to wireless terminal devices, and a core network for routing data between the access networks or between the wireless network and other types of data networks. In a wireless access network, radio resources are provided for allocation and used for transmitting data and control information. FIG. 1 shows an exemplary wireless access network 100 including a wireless access network node (WANN) or wireless base station 102 (herein referred to as wireless base station, base station, wireless access node, wireless access network node, or WANN) and a wireless terminal device or user equipment (UE) 104 (herein referred to as user equipment, UE, terminal device, or wireless terminal device) that communicates with one another via over-the-air (OTA) radio communication resources 106. The wireless access network 100 may be implemented as, as for example, a 2G, 3G, 4G/LTE, or 5G cellular radio access network. Correspondingly, the base station 102 may be implemented as a 2G base station, a 3G node B, an LTE eNB, or a 5G New Radio (NR) gNB. The user equipment 104 may be implemented as mobile or fixed communication devices installed with mobile identity modules for accessing the base station 102. The user equipment 104 may include but is not limited to mobile phones, laptop computers, tablets, personal digital assistants, wearable devices, distributed remote sensor devices, and desktop computers. Alternatively, the wireless access network 100 may be implemented as other types of radio access networks, such as Wi-Fi, Bluetooth, ZigBee, and WiMax networks.

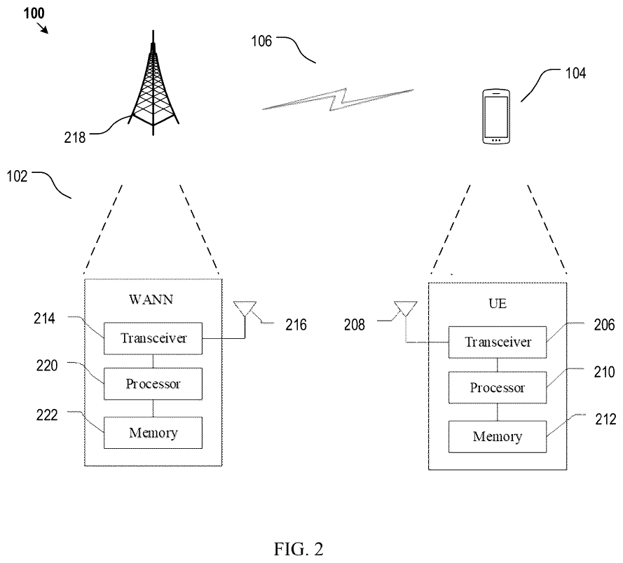

FIG. 2 further shows example processing components of the WANN 102 and the UE 104 of FIG. 1. The UE 104, for example, may include transceiver circuitry 206 coupled to one or more antennas 208 to effectuate wireless communication with the WANN 102 (or to other UEs). The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the, functions, methods, and processes described herein. Likewise, the WANN 102 may include transceiver circuitry 214 coupled to one or more antennas 216, which may include an antenna tower 218 in various forms, to effectuate wireless communications with the UE 104. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions, methods, and processes of the WANN 102 described herein.

### Wireless Communication Resource Scheduling/Signaling

Returning to FIG. 1, the radio communication resources for the over-the-air interface 106 may include a combination of frequency, time, and/or spatial communication resources organized into various resource units or elements in frequency, time, and/or space. The radio communication resources 106 in frequency domain may include portions of licensed radio frequency bands, portions of unlicensed ration frequency bands, or portions of a mix of both licensed and unlicensed radio frequency bands. The radio communication resources 106 available for carrying the wireless communication signals between the base station 102 and user equipment 104 may be further divided into physical downlink channels 110 for transmitting wireless signals from the base station 102 to the user equipment 104 and physical uplink channels 120 for transmitting wireless signals from the user equipment 104 to the base station 102. The physical downlink channels 110 may further include physical downlink control channels (PDCCHs) 112 and physical downlink shared channels (PDSCHs) 114. Likewise, the physical uplink channels 120 may further include physical uplink control channels (PUCCHs) 122 and physical uplink shared channels (PUSCHs) 124. For simplification, other types of downlink and uplink channels are not shown in FIG. 1 but are within the scope of the current disclosure. The control channels PDCCHs 112 and PUCCHs 122 may be used for carrying control information in the form of control messages 116 and 126, herein referred to as Downlink Control Information (DCI) messages or Uplink Control Information (UCI) messages. The shared channels (shared between data and control information) PDSCHs 114 and PUSCHs 124 may be allocated and used for communicating downlink data transmissions 118 and uplink data transmissions 128 between the base station 102 and the user equipment 104.

The allocation and configuration of the radio communication resources associated with the data channels, such as the PDSCHs and the PUSCHs may be provided by one or more resource scheduling DCIs carried in the PDCCHs. The PDCCHs may be shared by a plurality of UEs in the access network. In various approaches, a particular UE may be configured to perform blind decode procedures on a preconfigured UE-specific Search Space (USS) to detect and identify a payload of a resource scheduling DCI carried in the PDCCH that specifically targets the particular UE. The blind decoding may be performed on preconfigured monitoring occasions of the PDCCH associated with USS. Such monitoring occasions may be referred to as a set of PDCCH candidates. Each PDCCH candidate may be associated with a set of Control Channel Elements (CCEs). The UE may specifically use its Radio Network Temporary Identifier (RNTI) to decode the PDCCH candidates. The RNTI may be used to demask a PDCCH candidate's CRC. If no CRC error is detected, the UE determines that PDCCH candidate carries its own control information. The UE may then process the DCI and extract the resource allocation information pertaining to the PDSCH and/or PUSCH for receiving and/or transmitting data.

### Known Resource Scheduling Mechanisms

In the existing New Radio (NR) system, three different scheduling mechanism are currently known and used. A first known scheduling mechanism is self-scheduling. The scheduling command (e.g., DCI (Downlink Control Information) carried by PDCCH (Physical Downlink Control Channel)) and the scheduled channel/signal (e.g., PDSCH (Physical Downlink Shared Channel), PUSCH (Physical Uplink Shared Channel) and CSI-RS (Channel State Information-Reference Signal)) are transmitted on the same CC (Component Carrier).

A second known scheduling mechanism is cross-carrier scheduling. The scheduling command and the scheduled channel/signal are transmitted on different CCs. In this case, one CC can only be either a scheduling CC or a scheduled CC, but not both. If, for example, CC A is configured as the scheduling CC, then PDCCH on CC A can schedule the scheduled channel/signal on itself or on another CC. The channel/signal on CC A can only be scheduled by itself since CC A is a scheduling CC, thus it cannot be scheduled by other CCs. The CC of PCell (Primary Cell) in MCG (Master Cell Group) and PCell in SCG (Secondary Cell Group), also known as PSCell (Primary Secondary Cell), can only be configured as scheduling CC, but not the scheduled CC.

A third known scheduling mechanism is SCell (Secondary Cell) scheduling PCell. This is an extension of cross-carrier scheduling. In this case, the scheduling command on an CC of SCell can schedule channel/signal on itself or on the CC of PCell. The scheduling command on CC of PCell can schedule channel/signal on itself (i.e., PCell). In this case, the scheduling command on CC of PCell is not allowed to schedule channel/signal on the SCell. In these examples, each cell includes one or multiple downlink carriers and/or one or multiple uplink carriers.

However, the above three known scheduling mechanisms limit the scheduling flexibility.

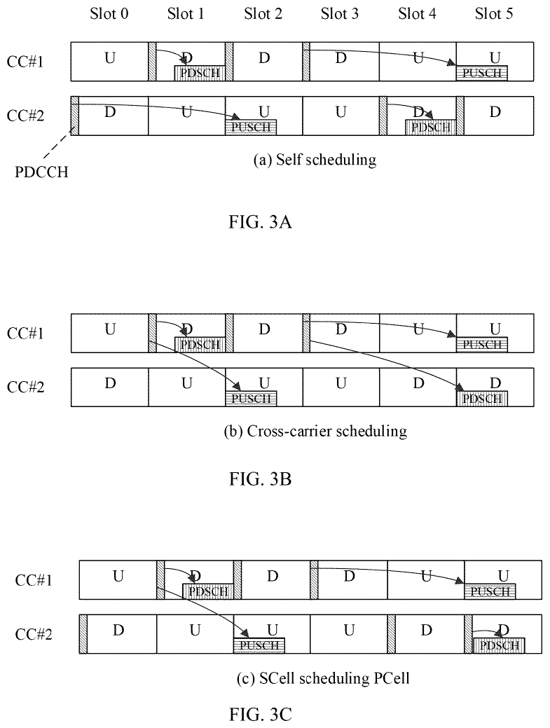

For example, for self-scheduling, the scheduling command on one CC can only be used to schedule channel/signal on the same CC. Referring to FIG. 3A as an example, the PDCCH on CC #1 and on CC #2 can only be used to schedule PDSCH/PUSCH on CC #1 and CC #2, respectively. Even if there are some PDCCH resources CC #2 (as shown in in slot 4 and slot 5), they cannot be used to schedule channel/signal on CC #1.

For cross-carrier scheduling, the scheduling command can only be configured on the scheduling CC. No PDCCH resource is configured on the scheduled CC. Referring to FIG. 3B as an example, CC #1 is a scheduling CC and CC #2 is a scheduled CC. Only PDCCH on CC #1 can be used to schedule PDSCH/PUSCH on CC #1 and CC #2. Even if there are downlink slots on CC #2 (e.g., slot 4 and slot 5), PDCCH resource is not allowed to be configured in these slots.

For SCell (Secondary Cell) scheduling PCell (Primary Cell), the PDCCH on a CC of SCell is allowed to schedule channel/signal on CC of SCell and PCell, while the PDCCH on a CC of PCell can only be used to schedule channel/signal on PCell.

Referring to FIG. 3C as an example, CC #1 is on SCell and CC #2 is on PCell. The PDCCH on CC #1 can schedule PDSCH/PUSCH on CC #1 and CC #2, but the PDCCH on CC #2 can only be used to schedule PDSCH/PUSCH on CC #2 only.

Note that, in FIGS. 3A-C, the gap symbol between DL slot and UL slot is not depicted. In various approaches, there may be a number (e.g., 2) of gap symbols after the DL symbols and before the UL symbols for DL and UL transition. The CC can be classified as DL (Downlink) carrier and UL (Uplink) carrier for DL transmission and UL transmission, respectively. Each of CC #1 and CC #2 in FIGS. 3A-C includes one DL carrier and one UL carrier. In other embodiments, one carrier may refer to one DL carrier only, or refer to one UL carrier only.

### Description of New Resource Scheduling Mechanism

As mentioned above, in accordance with the present disclosure, configurations are disclosed to enable a CC to schedule channel or signal on itself or on another CC, and to allow channel or signal to be scheduled on the CC by itself or by a different CC. In this manner, some or all of the CCs can schedule channel or signal on some or all of the other CCs. This overcomes the limitations of the existing known mechanisms discussed above and increases flexibility, reduces scheduling delay, and increases resource utilization efficiency.

In accordance with various embodiments, a method performed by the wireless access node 102, or by the UE 104, for scheduling for multiple component carriers (CCs) is disclosed. As part of this method, a base station 102 configures M CCs for the UE 104, where M is an integer number and is larger than 1. The UE receives this configuration from the base station 102. A scheduling command transmitted on an i^{th} CC of the M CCs can be used to schedule channel/signal on itself and can be used to schedule channel/signal on a set of other Nᵢ CCs among the M CCs, where Nᵢ is an integer number and Nᵢ is larger than 0 and Nᵢ is smaller than M, and where i is an integer number and 1≤i≤M. In other words, the all or some of the CCs of the group of M CCs for the UE 104 can be used to schedule channel or signal on itself and one or more other CCs in the group of M CCs.

Similarly, the channel/signal on the i^{th} CC can be scheduled by a scheduling command transmitted on itself and by a scheduling command transmitted on a set of other Pᵢ CCs, where Pᵢ is an integer number and Pᵢ is larger than 0 and Pᵢ is smaller than M. In other words, channel or signal for all of some of the CCs of the group of M CCs for the UE 104 can be scheduled by itself and one or more other CCs in the group of M CCs.

In various embodiments, each scheduling command can be used to schedule channel/signal on one CC or on multiple CCs. In some approaches, Nᵢ may be equal to M−1, which means that each CC is allowed to schedule channel/signal on itself and schedule channel/signal on all the other CCs in the group of M CCs for the UE 104. Similarly, in some approaches, Pᵢ may be equal to M−1, which means that channel/signal on each CC is allowed to be scheduled by a scheduling command on itself and on all the other CCs in the group of M CCs for the UE 104. However, in other embodiments, Nᵢ and/or Pᵢ may be less than M−1, so that each CC is allowed to schedule channel/signal on itself and schedule channel/signal on less than all of the other CCs in the group of M CCs, and so that each CC is allowed to be scheduled by a scheduling command on itself and on less than all of the other CCs in the group of M CCs.

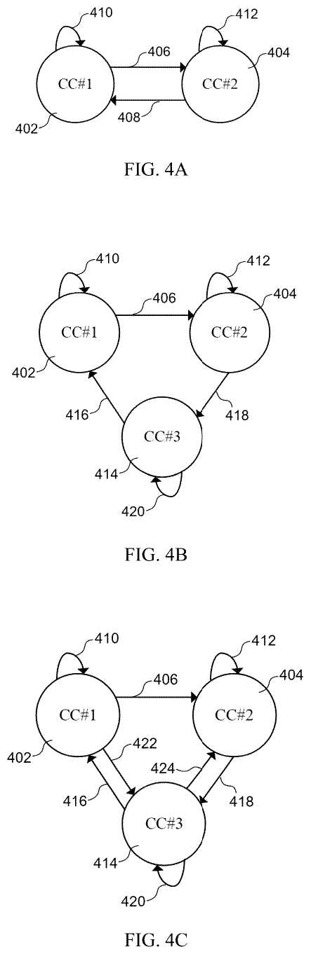

In one example, the base station 102 configures two CCs for the UE 104. The scheduling command transmitted in each CC can be used to schedule channel/signal on itself and can be used to schedule channel/signal on the other CC. As shown in FIG. 4A, the arrows indicate scheduling direction of scheduling commands. A scheduling command on CC #1 402 is allowed to schedule channel/signal on CC #1 402 (shown as arrow 410) and CC #2 404 (shown as arrow 406). A Scheduling command on CC #2 404 is allowed to schedule channel/signal on CC #2 404 (shown as arrow 412) and CC #1 402 (shown as arrow 408). In this example, in accordance with the variables discussed directly above, M is equal to 2, Nᵢ is equal to 1 for both CC #1 402 and CC #2 404 (i.e., N₁=1 and N₂=1), and Pᵢ is equal to 1 for both CC #1 402 and CC #2 404 (i.e., P₁=1 and P₂=1).

In another example, the base station 102 configures three CCs for the UE 104. In a specific example, as is shown in FIG. 4B, the scheduling command transmitted in the first CC 402 can be used to schedule channel/signal on itself and can be used to schedule channel/signal on the second CC 404. The scheduling command transmitted in the second CC 404 can be used to schedule channel/signal on itself and can be used to schedule channel/signal on the third CC 414. The scheduling command transmitted in the third CC 414 can be used to schedule channel/signal on itself and can be used to schedule channel/signal on the first CC 402. As is shown in the example of FIG. 4B, a scheduling command on CC #1 402 is allowed to schedule channel/signal on CC #1 402 (shown as arrow 410) and CC #2 404 (shown as arrow 406). A scheduling command on CC #2 404 is allowed to schedule channel/signal on CC #2 404 (shown as arrow 412) and CC #3 414 (shown as arrow 418). A scheduling command on CC #3 414 is allowed to schedule channel/signal on CC #3 414 (shown as arrow 420) and CC #1 402 (shown as arrow 416). In this example, in accordance with the variables discussed above, M is equal to 3, Nᵢ is equal to 2 for CC #1 402, CC #2 404, and CC #3 414 (i.e., N₁=2, N₂=2, and N₃=2), and Pᵢ is equal to 2 for CC #1 402, CC #2 404, and CC #3 414 (i.e., P₁=2, P₂=2, and P₃=2).

In another example, the base station 102 configures three CCs for the UE 104 in a different manner such that, as shown in FIG. 4C, the scheduling command transmitted in the first CC 402 can be used to schedule channel/signal on itself and can be used to schedule channel/signal on the second CC 404 or the third CC 414. The scheduling command transmitted in the second CC 404 can be used to schedule channel/signal on itself and can be used to schedule channel/signal on the third CC 414. The scheduling command transmitted in the third CC 414 can be used to schedule channel/signal on itself and can be used to schedule channel/signal on the first CC 402 or the second CC 404. As is shown in the example of FIG. 4C, a scheduling command on CC #1 402 is allowed to schedule channel/signal on CC #1 402 (shown as arrow 410), CC #2 404 (shown as arrow 406) and CC #3 414 (shown as arrow 422). A scheduling command on CC #2 404 is allowed to schedule channel/signal on CC #2 404 (shown as arrow 412) and CC #3 414 (shown as arrow 418) (noting that, in this illustrative example, it is not allowed to schedule channel/signal on CC #1 402). A scheduling command on CC #3 414 is allowed to schedule channel/signal on CC #1 402 (shown as arrow 416), CC #2 404 (shown as arrow 424), and CC #3 414 (shown as arrow 420). In this example, in accordance with the variables discussed above, M is equal to 3, Nᵢ is equal to 3, 2, and 3 for CC #1 402, CC #2 404, and CC #3 420, respectively (i.e., N₁=3, N₂=2, and N₃=3), and Pᵢ is equal to 2, 3, and 3 for CC #1 402, CC #2 404, and CC #3 420, respectively (i.e., P₁=2, P₂=3, and P₃=3). Although three example configurations are disclosed herein, the present disclosure is not so limited, and many different permutations or combinations of CC scheduling configurations are possible and are contemplated by the present disclosure.

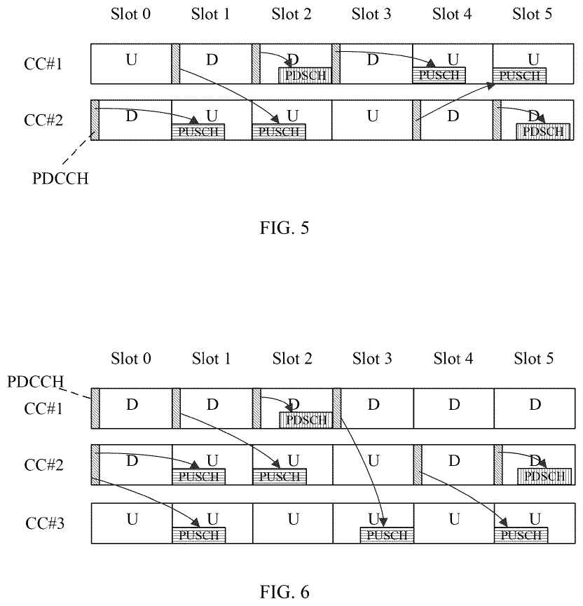

In the various embodiments disclosed herein, the scheduling command may refer to a physical layer scheduling command (e.g., DCI carried by PDCCH) and the higher layer scheduling command (e.g., MAC-CE) that used to schedule channel/signal. The channel/signal refers to downlink and uplink channel/signal, e.g., PDSCH, CSI-RS, PUSCH, SRS. In certain approaches, the CC refers to a downlink carrier and/or an uplink carrier. The scheduling command may be transmitted from the base station 102 to the UE 104 on the downlink carrier. For example, with reference to FIG. 5, CC #1 includes one downlink carrier (D) and one uplink carrier (U). The CC may also include a downlink carrier only or an uplink carrier only. For example, a CC in FDD (Frequency-Division Duplexing) band may only include one downlink carrier, while a CC in SUL (Supplementary Uplink) band may only include one downlink carrier. For example, with reference to FIG. 6, three CCs are configured, i.e., CC #1, CC #2 and CC #3. CC #1 includes one downlink carrier (D), CC #2 includes one downlink carrier (D) and one uplink carrier (U), and CC #3 includes one uplink carrier (U). The PDCCH on CC #1 may be allowed to schedule PDSCH on CC #1 and to schedule PUSCH on CC #2 and CC #3, and the PDCCH on CC #2 may be allowed to schedule PDSCH/PUSCH on CC #2 and to schedule PUSCH on CC #3. In various embodiments, one cell includes one or multiple CCs.

In various embodiments, if one CC includes only an uplink carrier, then it can only be scheduled by other CCs but not be scheduled by itself. Similarly, in various embodiments, if one CC includes only an uplink carrier, then there is no scheduling command transmitted on this CC.

In various embodiments, if the scheduling command on CC A can be used to schedule channel or signal on CC B, then CC A is the scheduling CC for CC B and CC B can be scheduled by CC A.

As scheduling mechanism disclosed herein for multiple CCs can reduce the scheduling delay and increase the efficiency of resource utilization. For example, with reference to FIG. 5, PDCCH on CC #1 is allowed to schedule PDSCH/PUSCH on CC #1 and CC #2. PDCCH on CC #2 is allowed to schedule PDSCH/PUSCH on CC #2 and CC #1. For example, when compared with the scheduling mechanisms disclosed in FIGS. 3A-C (showing the known scheduling mechanisms), the scheduling delay for PUSCH in slot 5 on CC #1 is reduced in FIG. 5. Meanwhile, the efficiency of resource utilization on CC #2 is increased because the PDCCH resource on CC #2 can be used to schedule PDSCH/PUSCH on CC #2 and CC #1 (rather than only for CC #2 as shown in FIGS. 3A and 3C).

### CC Configuration and Indication

In accordance with various embodiments, methods are disclosed to enable the new scheduling mechanism and to indicate which CCs are included in the scheduling configuration. In various approaches, the base station 102 indicates to the UE 104 to enable this new scheduling command and indicates the M CCs to the UE 104. The UE 104 may receive these indications from the base station 102. The M CCs can be indicated by a corresponding CC index. The scheduling command may indicate the CC index, and the scheduled channel/signal is transmitted on the CC corresponding to the indicated CC index. The scheduling command transmitted on each CC of the M CCs can schedule channel or signal on itself or on any other CCs. In other words, all the M CCs are the scheduling CC for each CC of the M CCs.

For example, the base station 102 may indicate the following Radio Resource Configuration (RRC) to the UE. An RRC parameter EnablingCollaborativeScheduling may be used to indicate to the UE 104 to enable this new scheduling mechanism. The RRC parameter CCIndex may be used to indicate the CC index. An example of this RRC parameter EnablingCollaborativeScheduling is shown below.

```
EnablingCollaborativeScheduling
{
    CCIndex 1
    CCIndex 2
    CCIndex 3
}
```

As an illustrative example, three CCs with CC indexes 1, 2, and 3 are indicated to the UE 104 for this new scheduling mechanism, where a scheduling command transmitted on CC with index 1 is allowed to schedule channel/signal on the CCs with indexes 1, 2, and 3. A scheduling command transmitted on CC with index 2 is allowed to schedule channel/signal on the CCs with indexes 1, 2 and 3. A scheduling command transmitted on CC 3 is also allowed to schedule channel/signal on the CCs with index 1, 2 and 3. In certain embodiments, a DCI field (e.g., CIF (Carrier Indication Field)) in the scheduling DCI may be used to indicate a target CC index for the scheduled PDSCH/PUSCH. For example, if the CIF in the DCI transmitted on CC with index 2 is 1, then the PDSCH or PUSCH scheduled by this DCI is transmitted on CC 1.

In another approach, the base station 102 may indicate to the UE 104 to enable the new scheduling mechanism and may indicate M CC indexes and the corresponding scheduling CCs to the UE 104. The UE 104 may receive these indications from the base station 102. In various examples, the base station 102 may not need to configured the CC as the scheduling CC for itself. For example, by default, the CC itself can be used as the scheduling CC for itself. Each CC may be configured with one or multiple scheduling CCs in addition to itself. In this case, in order to schedule channel/signal on one CC, the scheduling command can only be transmitted on the CC itself or on the corresponding scheduling CCs for this CC. The scheduling command indicates the CC index, and the scheduled channel/signal is transmitted on the CC corresponding to the indicated CC index.

For example, in this approach, the base station 102 may indicate the following RRC configuration to the UE 104. In various examples, RRC parameter EnablingCollaborativeScheduling may be used to indicate to the UE 104 to enable this new scheduling mechanism. The scheduling CC may be indicated by RRC parameter CarrierIndex. The scheduling CC for each CC may be configured by schedulingCarrierIndex. As an illustrative example, for a CC with index 1 (CC #1), the scheduling CC is configured as the CC with index 2 and 3 (i.e., CC #2 and CC #3). Thus, in order to schedule channel/signal on CC #1, the scheduling command can be transmitted on itself (CC #1) and on the CC #2 and CC #3. Continuing with this illustrative example, for CC #2, the scheduling CC may be configured as CC #1. Thus, in order to schedule channel/signal on CC #2, the scheduling command can be transmitted on itself (CC #2) and on the CC #1. Still continuing with this illustrative example, for CC #3, the scheduling CC is configured as CC #1 and CC #2. Thus, in order to schedule channel/signal on CC #3, the scheduling command can be transmitted on itself (CC #3) and on the CC #1 and CC #2. An example of this RRC parameter EnablingCollaborativeScheduling for each CC is shown below.

### Example RRC Configuration for CC #1:

```
    EnablingCollaborativeScheduling
    {
      CarrierIndex 1,
      schedulingCarrierIndex {2, 3}
    }
Example RRC configuration for CC#2:
    EnablingCollaborativeScheduling
    {
      CarrierIndex 2,
      schedulingCarrierIndex {1}
    }
```

### Example RRC Configuration for CC #3:

```
EnablingCollaborativeScheduling
{
  CarrierIndex 3,
  schedulingCarrierIndex {1, 2}
}
```

In another approach, the base station 102 may configure M CCs for the UE 104. In a particular example, the base station 102 may configure the 1st CC as the scheduling CC for the 2nd CC, configure the 2nd CC as the scheduling CC for the 3rd CC, and so forth, and configures the (M−1)th CC as the scheduling CC for the Mth CC, and configures the Mth CC as the scheduling CC for the 1st CC. In this example, in order to scheduling channel/signal on the 1st CC, the scheduling command can be transmitted on itself and on the Mth CC. In order to scheduling channel/signal on the 2nd CC, the scheduling command can be transmitted on itself and on the 1st CC, etc.

Put another way, the method can be understood as the base station 102 configuring (and the UE 104 receiving the configuration from the base station 102 of) a k^{th} CC of the M CCs as a scheduling CC for a (k+1)^{th} CC of the M CCs, where k is an integer and 1≤k≤M−1; and configuring an M^{th} CC of the M CCs as a scheduling CC for a first CC of the M CCs. In order to schedule channel or signal on each one of the M CCs, a scheduling command is transmitted on the CC itself or on a corresponding scheduling CC for the CC.

In another particular example, if base station 102 configures two CCs for the UE 104, the base station may configure the first CC as the scheduling CC for the second CC and configures the second CC as the scheduling CC for the first CC. This configuration indicates to the UE to enable this new scheduling mechanism. In this case, the scheduling command transmitted on the first CC and on the second CC are allowed to schedule channel/signal on the first CC. The scheduling command transmitted on the first CC and on the second CC are allowed to schedule channel/signal on the second CC.

For example, the base station 102 may indicate the following RRC configuration to the UE 104 by configuring the CC with index 2 (CC #2) as the scheduling CC for the CC with index 1 (CC #1), and configuring CC #1 as the scheduling CC for CC #2. As such, in order to schedule channel/signal on CC #1, the scheduling command can be transmitted on CC #1 and CC #2. In order to schedule channel/signal on CC #2, the scheduling command can be transmitted on CC #1 and CC #2. In various embodiments, the existing RRC configuration of CrossCarrierSchedulingConfig may be utilized, an example of which is provided for each CC below:

### Example RRC Configuration for CC #1

```
CrossCarrierSchedulingConfig
{
        CarrierIndex 1,
        scheduling CarrierIndex {2}
}
Example RRC configuration for CC#2
      CrossCarrierSchedulingConfig
      {
        CarrierIndex 2,
        scheduling CarrierIndex {1}
      }
```

### Search Space Set Configuration

In certain approaches, in order to utilize the disclosed new scheduling mechanism, the CCs may need to be configured with the same search space. Stated another way, if there is a search space with a same index configured on more than one CC, then the PDCCH carried in the PDCCH candidates associated with the search space on each of those CCs can be used to schedule channel/signal on any CC among those CCs. Stated yet another way, the method can be understood as the base station 102 configuring (and the UE 104 receiving the configuration from the base station 102 of) a same search space index for a search space for the i^{th} CC and the Nᵢ other CCs of the M CCs, wherein the first scheduling command is carried in a PDCCH candidate associated with the search space with the same search space index.

As an illustrative example, if CC #1 is configured as the scheduling CC for CC #2, and CC #2 is configured as the scheduling CC for CC #1, and a search space (SS) with index s (SS #s) is configured on CC #1, and another SS with index s (SS #s) is also configured on CC #2, then the PDCCH carried in the PDCCH candidates associated with the search space (SS #s) on CC #1 is used to schedule channel/signal on CC #1 and to schedule channel/signal on CC #2. Also, the PDCCH carried in the PDCCH candidates associated with the search space (SS #s) on CC #2 is used to schedule channel/signal on CC #1 and to schedule channel/signal on CC #2.

When the PDCCH is monitored in PDCCH candidates associated with one search space on one CC, the UE 104 follows the search space configuration on this CC independent of whether the PDCCH is used to schedule channel/signal on this CC or on another CC. The search space configuration at least includes the following: The associated control resource set, which is used to configure a time/frequency control resource set in which to search for downlink control information; Time location of the search space, for example time location of search space configured by periodicity and starting offset within the periodicity; or The number of PDCCH candidates.

In an illustrative example, CC #1 and CC #2 are configured as the scheduling CC for CC #2 and CC #1, respectively. Two search spaces with index 1 and 2 (i.e., SS #1 and SS #2) are configured on CC #1. Two search spaces with index 2 and 3 (i.e., SS #2 and SS #3) are configured on CC #2. Because SS #2 is configured on both CC #1 and CC #2, the PDCCH monitored on the PDCCH candidates associated with SS #2 on CC #1 can be used to schedule channel/signal on CC #1 and CC #2. Similarly, the PDCCH monitored on the PDCCH candidates associated with SS #2 on CC #2 can be used to schedule channel/signal on CC #1 and CC #2. However, because SS #1 and SS #3 are configured on CC #1 and CC #2, respectively, the PDCCH monitored on the PDCCH candidates associated with SS #1 and SS #3 can only be used to schedule channel/signal on CC #1 and CC #2, respectively. The PDCCH monitored on the PDCCH candidates associated with SS #1 cannot be used to schedule channel/signal on CC #2. Similarly, the PDCCH monitored on the PDCCH candidates associated with SS #3 cannot be used to schedule channel/signal on CC #1.

In another approach, the search space configured in each CC may be associated with one or multiple scheduled CCs. The PDCCH monitored in the PDCCH candidates associated with the search space can be used to schedule channel/signal transmitted on the one or multiple CCs associated with this search space. Stated yet another way, the method can be understood as the base station 102 indicating (and the UE 104 receiving the indication from the base station 102 of) one or more search spaces for the it CC, wherein each of the one or more search spaces is associated with one or more CCs of the M CCs. The first scheduling command carried in a PDCCH candidate associated with the one or more search spaces schedules channel or signal on the one or more CCs associated with the search space.

As another illustrative example, CC #1 and CC #2 are configured as the scheduling CC for CC #2 and CC #1, respectively. Two search spaces with index 1 and 2 (i.e., SS #1 and SS #2) are configured on CC #1. If SS #1 is associated with CC #1 and SS #2 is associated with CC #1 and CC #2, the PDCCH monitored on the PDCCH candidates associated with SS #1 can only be used to schedule channel/signal on CC #1. However, the PDCCH monitored on the PDCCH candidates associated with SS #2 can be used to schedule channel/signal on CC #1 and CC #2.

### Blind Detection (BD) and Control Channel Element (CCE) Budget

In order to alleviate UE implementation complexity, a maximum number of monitored PDCCH candidates for a DL Bandwidth Part (BWP) with Subcarrier Spacing (SCS) configuration u for a UE 104 per slot or per span for operation with a CC is defined. This is also known as the BD (Blind Detection) budget for the UE.

Similarly, a maximum number of non-overlapped CCEs (Control Channel Elements) for a DL BWP with SCS configuration u that a UE 104 is expected to monitor corresponding PDCCH candidates per slot or per span for operation with a CC is defined, and is known as the CCE budget for the UE

Per the above disclosed embodiments, the base station 102 can configure M CCs for the UE 104, where M is integer number and M is larger than 1, and the scheduling command transmitted on one CC can be used to schedule channel/signal on itself and can be used to schedule channel/signal on the other N CCs among the M CCs, where N is an integer larger than 0 and smaller than M. In other words, the scheduling command transmitted on one CC can be used to schedule channel/signal on N+1 CCs out of the M CCs. Each scheduling command can be used to schedule channel/signal on one CC or on multiple CCs.

If the scheduling command is transmitted on the i^{th} CC of the M CCs with an SCS configuration u, then the maximum number of monitored PDCCH candidates for the UE 104 per slot or per span for operation with the Nᵢ+1 CCs may be defined as Mᵤ, wherein the Nᵢ+1 CCs include the i^{th} CC and the Nᵢ other CCs of the M CCs. The UE 104 is not expected to monitor more than Mᵤ PDCCH candidates on this scheduling CC for the UE 104 per slot or per span for scheduling channel/signal on these Nᵢ+1 CCs. Mᵤ is an integer number larger than 0, and it may be defined according to the UE capability.

Similarly, if the scheduling command is transmitted on the i^{th} CC of the M CCs with an SCS configuration u, then the maximum number of non-overlapped CCEs that the UE 104 is expected to monitor corresponding PDCCH candidates per slot or per span for operation with the Nᵢ+1 CCs may be defined as Cᵤ. The UE 104 is not expected to monitor more than Cᵤ non-overlapped CCEs on this scheduling CC for the UE 104 per slot or per span for scheduling channel/signal on these Nᵢ+1 CCs. Cᵤ is integer number larger than 0, and it may also be defined according to the UE capability.

In an alternative approach, the base station 102 may configure the M CCs for the UE 104, where M is integer number and M is larger than 1. The channel/signal on the i^{th} CC can be scheduled by a scheduling command transmitted on itself and by a scheduling command transmitted on a set of other Pᵢ CCs, where Pᵢ is an integer number and Pᵢ is larger than 0 and Pᵢ is smaller than M. In other words, the channel/signal on the i^{th} CC can be scheduled by Pᵢ+1 CCs, which include the i^{th} CC and other Pᵢ CCs of the M CCs

Because the channel/signal on one CC can be scheduled by the command transmitted on Pᵢ+1 CCs that include itself (e.g., the i^{th} CC of the M CCs) and the other Pᵢ CCs, Pᵢ parameters (i.e., a₁, a₂, . . . , a_{P}_{ᵢ}) are indicated to the UE 104 to split the BD budget and CCE budget, where 0≤aₖ≤1, 0≤a₁+ . . . +aₖ+ . . . a_{P}_{ᵢ}≤1, and k is an integer where 1≤k≤Pᵢ.

Alternatively, since the channel/signal on CC can be scheduled by the command transmitted on the Pᵢ+1 CCs that includes itself and the Pᵢ other CCs, Pᵢ parameters (i.e., a₁, a₂, . . . , a_{P}_{ᵢ}) are indicated to the UE to split the BD budget and CCE budget, where 0≤aₖ≤1, 0≤a₁+ . . . +aₖ+ . . . a_{P}_{ᵢ}≤1, and k is an integer where 1≤k≤Pᵢ.

If the scheduled channel/signal is transmitted on the i^{th} CC with SCS configuration u, then the maximum number of monitored PDCCH candidates for a UE per slot or per span for operation with the k^{th} CC is defined as Mₖ=aₖ·Mᵤ, where 1≤k≤P. Also, the maximum number of monitored PDCCH candidates for a UE per slot or per span for operation with the (Pᵢ+1)^{th} CC is defined as M_{P+1}=Mᵤ−ΣᵢMᵢ, where 1≤i≤P. Also, Mᵢ=0 means that no PDCCH can be monitored on the i^{th} CC for scheduling channel/signal on the CC. Also, M_{P+1}=0 means that no PDCCH can be monitored on the (P+1)^{th} CC for scheduling channel/signal on the CC. Also, Mᵤ is the maximum number of monitored PDCCH candidates for a UE per slot or per span for operation CC with SCS configuration u. If aᵢ·Mᵤ is not an integer, a round up operation or round down operation may be performed for aᵢ·Mᵤ, i.e., Mᵢ=┌aᵢ·Mᵤ┐ or Mᵢ=└aᵢ·Mᵤ┘.

Also, wherein a maximum number of non-overlapped CCEs for a UE per slot or per span for operation with a k^{th} CC of the M CCs is defined as Cₖ=aₖ·Cᵤ, and the maximum number of non-overlapped CCEs for a UE per slot or per span for operation with a (P+1)^{th} CC of the M CCs is defined as M_{P+1}=Cᵤ−ΣₖCₖ, wherein Cᵤ is the non-overlapped CCEs budget for the i^{th} CC.

### PDCCH Candidate Location

In various examples, the CCE indexes for one PDCCH candidate are based on the CC index of the scheduled CC. As discussed above, in accordance with the new scheduling mechanism of the present disclosure, a scheduling command transmitted on one CC can be used to schedule channel/signal on itself and can be used to schedule channel/signal on the other N CCs among the M CCs, where N is an integer larger than 0 and smaller than M. In other words, the scheduling command transmitted on one CC can be used to schedule channel/signal on N+1 CCs out of the M CCs. However, if CCE indexes for one PDCCH candidate on the scheduling CC are still based on the CC index of the scheduled CC, it increases the burden of PDCCH candidate detection for the UE 104.

In order to reduce this burden, in various embodiments, a unified CC index is used for determining the CCE indexes for PDCCH candidates. In various approaches, the unified CC index can be the CC index of the CC carrying the PDCCH, the CC index configured by Radio Resource Configuration (RRC) signaling, or a smallest CC index among the CCs that can be scheduled by the PDCCH monitored in the scheduling CC.

For example, the base station 102 configures the M CCs for the UE 104. The CCE indexes for PDCCH candidates carrying the PDCCH scheduling channel/signal on the N+1 CCs may be determined based on the same CC index n_{ci}, which, in certain approaches, is the CC index configured by RRC signaling.

### Downlink Control Information (DCI) Size

In certain applications, the DCIs carried by PDCCHs for scheduling channel/signal on different CCs may have different DCI bit sizes. To avoid a monitoring burden on the UE side, the following is proposed.

For DCIs with the same DCI format carried by PDCCH on the CC for scheduling channel/signal on the N+1 CCs, the maximum DCI bit size for these DCIs is X. All the DCIs with this DCI format carried by PDCCH on the CC for scheduling channel/signal on these N+1 CCs may then be padded with zeros or ones at the end of each DCI to align its DCI bit size to X. Returning to FIG. 5, as an example, if the DCI size of DCI format 0_1 carried by PDCCH on CC #1 for scheduling PUSCH on CC #1 is 80 bits, and the DCI size of DCI format 0_1 carried by PDCCH on CC #1 for scheduling PUSCH on CC #2 is 85 bits, then 5 bits of zeros or ones are padded at the end of DCI format 0_1 for scheduling PUSCH on CC #1 such that the DCI size of these two DCI formats 0_1 are aligned.

In another example, DCIs with a same DCI format carried by the scheduling command on the i^{th} CC are padded with zeros or ones at the end of each DCI to match a DCI bit length corresponding to a maximum DCI bit size of the DCI carried by the scheduling command on the i^{th} CC.

### PDCCH Monitoring Occasions

In various applications, different UEs have different PDCCH monitoring capabilities. As such, a reference Subcarrier Spacing (SCS) configuration is defined. The following methods can be used to determine the reference SCS configuration u.

In a first approach, the reference SCS configuration u is configured by the RRC signaling.

In a second approach, a smallest SCS configuration u among all the M CCs configured to the UE 104 is determined as the reference SCS configuration u. In this case, the slot length of the reference SCS configuration is the longest among all the M CCs.

In a third approach, a largest SCS configuration u among all the M CCs configured to the UE 104 is determined as the reference SCS configuration. In this case, the slot length of the reference SCS configuration is the shortest among all the M CCs.

In a fourth approach, among all the M CCs configured to the UE 104, the SCS configuration u of the CC in PCell is determined as the reference SCS configuration.

In a fifth approach, among all the M CCs configured to the UE 1012, the SCS configuration u of the CC with the smallest CC index is determined as the reference SCS configuration.

The above five methods are workable as long as the base station 102 and the UE 104 have a same understanding of the reference SCS configuration. To accommodate different UE capabilities, the following three alternatives are disclosed.

In the first alternative, a reference SCS configuration is defined. Within the time duration of each slot of the reference SCS configuration, only up to one CC is allowed to be configured with PDCCH monitoring occasions.

With reference to the third approach discussed above as an example, if CC #1 is configured with SCS of 15 KHz (u=0), and CC #2 is configured with SCS of 30 KHz (u=1), then the SCS configuration of CC #2 would be determined as the reference SCS configuration, i.e., SCS of 30 KHz (u=1). In this case, in each slot corresponding to an SCS of 30 KHz, i.e., 0.5 ms, only up to one CC is allowed to be configured with PDCCH monitoring occasions. For example, PDCCH monitoring occasions on CC #1 and CC #2 may be configured on the slot with odd indexes and even indexes, respectively.

In the second alternative, the UE 104 may only need to monitor PDCCH on up to X CCs within the time duration of each slot of the reference SCS configuration, where X is an integer number and 1≤X≤M. X may be based on UE capability. To reduce the UE PDCCH monitoring complexity, X can be set as 1 in various examples, which means the UE 104 only needs to monitor PDCCH on up to one CC within the time duration of each slot of the reference SCS configuration.

If there are more than X CCs configured with PDCCH monitoring occasions within the time duration of one slot of the reference SCS configuration, then the following two methods may be applied to determine how to monitor the PDCCH.

In a first method, the UE 104 may only need to monitor PDCCH on up to X CCs with smaller CC indexes. For example, if three CCs are configured for the UE 104 (e.g., with CC indexes CC #1, CC #2, and CC #3), and all of the three CCs are configured with PDCCH occasions in one slot of the reference SCS configuration, if X is 2, then the UE 104 only needs to monitor PDCCH on CC #1 and CC #2, being the CCs with smaller CC indexes.

In a second method, the UE 104 may only need to monitor PDCCH on up to Y CCs with smaller SCS configuration u, where Y=Σᵤ₌₀^{U}Xᵤ. U is an integer number and is determined such that Σᵤ₌₀^{U}Xᵤ≤X and Σᵤ₌₀^{U+1}Xᵤ>X. In other words, Y is not larger than X. For example, if four CCs are configured for the UE 104 (e.g., CC #1 with SCS configuration u=0, CC #2 with SCS configuration u=0, CC #3 with SCS configuration u=1, and CC #4 with SCS configuration u=1), and all the four CCs are configured with PDCCH occasions in one slot of the reference SCS configuration, if X is 3, then the UE 104 only needs to monitor PDCCH on CC #1 and CC #2 because U is equal to 0 in this case.

In the third alternative, the base station 102 indicates a periodic PDCCH monitoring pattern to the UE 104. The UE 104 determines the CC to monitor PDCCH based on the periodic PDCCH monitoring pattern. The pattern may be indicated by a bit sequence with X bits. Each ┌log 2(M)┐ bit(s) of the pattern may correspond to a slot for a reference SCS configuration. The value of each ┌log 2(M)┐ bit(s) of the pattern may indicate the target CC, on which the UE 104 needs to monitor PDCCH. The period may be T=X/┌log 2(M)┐ slots with reference SCS configuration. T is expected to be an integer number larger than 0.

With reference to FIG. 5 as an example, the UE 104 is configured with two CCs (i.e., CC #1 and CC #2). The UE 104 receives an indication from the base station 102 of a periodic PDCCH monitoring pattern of “10001.” Each one (i.e., ┌log 2(2)┐=1) bit corresponds to a slot for a reference SCS configuration. In this example, the first bit with value 1 indicates that the UE 104 needs to monitor PDCCH on CC #2 during the first slot (slot 0) of the reference SCS configuration within each period. The last bit with value 1 indicates that the UE 104 also needs to monitor PDCCH on CC #2 during the last slot (slot 4) of reference SCS configuration within each period. The other three bits with value 0 indicate that the UE 104 needs to monitor PDCCH on CC #1 during the second, third, and fourth slots (slot 1, slot 2 and slot 3) of reference SCS configuration within each period. The period in this example is five slots with the reference SCS configuration. The reference SCS configuration is the same as the SCS configuration as CC #1 and CC #2 in this example.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation/example/approach” as used herein does not necessarily refer to the same embodiment and the phrase “in another embodiment/implementation/example/approach” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method performed by a wireless access node for scheduling for multiple component carriers (CCs), the method comprising:
configuring M CCs for a wireless terminal device, where M is an integer number larger than 1,
wherein a first scheduling command transmitted on an i^{th} CC of the M CCs schedules channel or signal on the i^{th} CC or on at least one of Nᵢ other CCs of the M CCs, where Nᵢ is an integer number larger than 0 and smaller than M, and where i is an integer number and 1≤i≤M,
wherein a channel or signal on the i^{th} CC is scheduled by a second scheduling command transmitted on the i^{th} CC or on at least one of Pᵢ other CCs of the M CCs, where Pᵢ is an integer larger than 0 and smaller than M, and
wherein each scheduling command schedules channel or signal on one or more CCs of the M CCs.

2. The method according to claim 1, wherein:
Nᵢ is equal to M−1.

3. The method according to claim 1, wherein:
Pᵢ is equal to M−1.

4. The method according to claim 1, wherein:
an individual CC of the M CCs includes at least one of a downlink carrier or an uplink carrier.

5. The method according to claim 1, further comprising:
indicating to the wireless terminal device to enable scheduling for the M CCs; and
indicating the M CCs for which scheduling is enabled.

6. The method according to claim 1, further comprising:
indicating to the wireless terminal device to enable scheduling for the M CCs; and
indicating M CC indexes corresponding to the M CCs and corresponding scheduling CCs for the M CCs,
wherein, in order to schedule channel or signal on each one of the M CCs, a scheduling command is transmitted on the CC itself or on a corresponding scheduling CC for the CC.

7. The method according to claim 1, further comprising:
configuring a k^{th} CC of the M CCs as a scheduling CC for a (k+1)^{th} CC of the M CCs, where k is an integer and 1≤k≤M−1; and
configuring an M^{th} CC of the M CCs as a scheduling CC for a first CC of the M CCs,
wherein, in order to schedule channel or signal on each one of the M CCs, a scheduling command is transmitted on the CC itself or on a corresponding scheduling CC for the CC.

8. The method according to claim 1, further comprising:
configuring a same search space index for a search space for the i^{th} CC and the Nᵢ other CCs of the M CCs,
wherein the first scheduling command is carried in a PDCCH candidate associated with the search space with the same search space index.

9. The method according to claim 1, further comprising:
indicating to the wireless terminal device one or more search spaces for the i^{th} CC,
wherein each of the one or more search spaces is associated with one or more CCs of the M CCs, and
wherein the first scheduling command carried in a PDCCH candidate associated with the one or more search spaces schedules channel or signal on the one or more CCs associated with the search space.

10. The method according to one of claim 8 or 9, further comprising:
indicating to the wireless terminal device a search space configuration for the one or more search spaces including at least one of the following:
an associated control resource set used to configure a time/frequency control resource set in which to search for downlink control information,
time location of the one or more search spaces configured by periodicity and starting offset within the periodicity, or
a number of PDCCH candidates.

11. The method according to claim 1,
wherein the first scheduling command is transmitted on the i^{th} CC of the M CCs with Subcarrier Spacing (SCS) configuration u,
wherein a maximum number of monitored PDCCH candidates for the wireless terminal device per slot or per span for operation with Nᵢ+1 CCs is defined as Mᵤ, where Mᵤ is an integer larger than 0, and
wherein the Nᵢ+1 CCs include the i^{th} CC and the Nᵢ other CCs of the M CCs.

12. The method according to claim 1, further comprising:
indicating Pᵢ parameters (aᵢ, a₂, . . . , a_{P}_{ᵢ}) to the wireless terminal device to split a monitored PDCCH candidates budget for the second scheduling command for Pᵢ+1 CCs, where 0≤aₖ≤1, 0≤a₁+ . . . +aₖ+ . . . +a_{P}_{ᵢ}≤1, and k is an integer where 1≤k≤Pᵢ,
wherein the Pᵢ+1 CCs include the i^{th} CC and the Pᵢ other CCs of the M CCs,
wherein a maximum number of monitored PDCCH candidates for the wireless terminal device per slot or per span for operation with a k^{th} CC of the M CCs is defined as Mₖ=aₖ·Mᵤ, and
the maximum number of monitored PDCCH candidates for the wireless terminal device per slot or per span for operation with a (P+1)^{th} CC of the M CCs is defined as M_{P+1}=Mᵤ−ΣᵢMᵢ, and
wherein Mᵤ is the monitored PDCCH candidates budget for the i^{th} CC.

13. The method according to claim 1,
wherein the first scheduling command is transmitted on the i^{th} CC with Subcarrier Spacing (SCS) configuration u,
wherein a maximum number of monitored non-overlapped Control Channel Elements (CCEs) candidates for the wireless terminal device per slot or per span for operation with Nᵢ+1 CCs is defined as Cᵤ, where Cᵤ is an integer larger than 0, and
wherein the Nᵢ+1 CCs include the i^{th} CC and the Nᵢ other CCs of the M CCs.

14. The method according to claim 1, further comprising:
indicating Pᵢ parameters (aᵢ, a₂, . . . , a_{P}_{ᵢ}) to the wireless terminal device to split a non-overlapped CCE budget for the second scheduling command for Pᵢ+1 CCs, where 0≤aₖ≤1, 0≤a₁+ . . . +aₖ+ . . . +a_{P}_{ᵢ}≤1, and k is an integer where 1≤k≤Pᵢ,
wherein the Pᵢ+1 CCs include the i^{th} CC and the Pᵢ other CCs of the M CCs,
wherein a maximum number of non-overlapped CCEs for the wireless terminal device per slot or per span for operation with a k^{th} CC of the M CCs is defined as Cₖ=aₖ·Cᵤ, and
the maximum number of non-overlapped CCEs for the wireless terminal device per slot or per span for operation with a (P+1)^{th} CC of the M CCs is defined as M_{P+1}=Cᵤ−ΣₖCₖ,
wherein Cᵤ is the non-overlapped CCEs budget for the i^{th} CC.

15. The method according to claim 1,
wherein Control Channel Element (CCE) indexes for PDCCH candidates are determined based on a unified CC index, wherein the unified CC index is one of the following:
a CC index of a CC carrying a PDCCH;
a CC index configured by Radio Resource Configuration (RRC) signaling; or
a smallest CC index among a set of CCs that can be scheduled by the PDCCH monitored in the scheduling CC.

16. The method according to claim 1,
wherein Downlink Control Information (DCIs) with a same DCI format carried by the first scheduling command on the i^{th} CC are padded with zeros or ones at the end of each DCI to match a DCI bit length corresponding to a maximum DCI bit size of the DCI carried by the first scheduling command on the i^{th} CC.

17. The method according to claim 1,
wherein a reference Subcarrier Spacing (SCS) configuration u is defined according to one of the following:
the reference SCS configuration u is configured by Radio Resource Configuration (RRC) signaling;
a smallest SCS configuration u among all the M CCs is determined as the reference SCS configuration u;
a largest SCS configuration u among all the M CCs is determined as the reference SCS configuration u;
among all the M CCs configured, a SCS configuration of a CC in PCell is determined as the reference SCS configuration u; or
among all the M CCs configured to the UE, a SCS configuration of a CC with a smallest CC index is determined as the reference SCS configuration u.

18. The method according to one of claims 1 and 17, wherein
within a time duration of each slot of the reference SCS configuration u, only up to one CC is configured with PDCCH monitoring occasions.

19. The method according to one of claims 1 and 17,
wherein the wireless terminal device is configured to monitor PDCCH on only up to X CCs with a smaller CC index of the M CCs, within a time duration of each slot of the reference SCS configuration u, where X is an integer number based on a capability of the wireless terminal device, and where 1≤X≤M.

20. The method according to one of claims 1 and 17, further comprising:
indicating a periodic PDCCH monitoring pattern to the wireless terminal device which dictates a CC to monitor PDCCH based on the periodic PDCCH monitoring pattern,
wherein the periodic PDCCH monitoring pattern is indicated by a bit sequence with X bits, wherein X is an integer larger than 1,
wherein each ┌log 2(M)┐ bits of the periodic PDCCH monitoring pattern corresponds to a slot for a reference Subcarrier Spacing (SCS) configuration, and
wherein a value of each ┌log 2(M)┐ bits of the periodic PDCCH monitoring pattern indicates a target CC on which the wireless terminal device needs to monitor PDCCH.

21. A method performed by a wireless terminal device for scheduling for multiple component carriers (CCs), the method comprising:
receiving, from a wireless access node, a configuration of M CCs for the wireless terminal device, where M is an integer number larger than 1,
wherein a first scheduling command transmitted on an i^{th} CC of the M CCs schedules channel or signal on the i^{th} CC or on at least one of Nᵢ other CCs of the M CCs, where Nᵢ is an integer number larger than 0 and smaller than M, and where i is an integer number and 1≤i≤M,
wherein a channel or signal on the i^{th} CC is scheduled by a second scheduling command transmitted on the i^{th} CC or on at least one of Pᵢ other CCs of the M CCs, where Pᵢ is an integer larger than 0 and smaller than M, and
wherein each scheduling command schedules channel or signal on one or more CCs of the M CCs.

22. The method according to claim 21, wherein:
Nᵢ is equal to M−1.

23. The method according to claim 21, wherein:
Pᵢ is equal to M−1.

24. The method according to claim 21, wherein:
an individual CC of the M CCs includes at least one of a downlink carrier or an uplink carrier.

25. The method according to claim 21, further comprising:
receiving an indication from the wireless access node to enable scheduling for the M CCs; and
receiving an indication from the wireless access node indicating the M CCs for which scheduling is enabled.

26. The method according to claim 21, further comprising:
receiving an indication from the wireless access node indicating to enable scheduling for the M CCs; and
receiving an indication from the wireless access node indicating M CC indexes corresponding to the M CCs and corresponding scheduling CCs for the M CCs,
wherein, in order to schedule channel or signal on each one of the M CCs, a scheduling command is transmitted on the CC itself or on a corresponding scheduling CC for the CC.

27. The method according to claim 21, further comprising:
receiving a configuration of a k^{th} CC of the M CCs as a scheduling CC for a (k+1)^{th} CC of the M CCs, where k is an integer and 1≤k≤M−1; and
receiving a configuration of an M^{th} CC of the M CCs as a scheduling CC for a first CC of the M CCs,
wherein, in order to schedule channel or signal on each one of the M CCs, a scheduling command is transmitted on the CC itself or on a corresponding scheduling CC for the CC.

28. The method according to claim 21, further comprising:
receiving a configuration of a same search space index for a search space for the i^{th} CC and the Nᵢ other CCs of the M CCs,
wherein the first scheduling command is carried in a PDCCH candidate associated with the search space with the same search space index.

29. The method according to claim 21, further comprising:
receiving from the wireless access node an indication of one or more search spaces for the i^{th} CC
wherein each of the one or more search spaces is associated with one or more CCs of the M CCs, and
wherein the first scheduling command carried in a PDCCH candidate associated with the one or more search spaces schedules channel or signal on the one or more CCs associated with the search space.

30. The method according to one of claims 28 or 29, further comprising:
receiving from the wireless access node an indication of a search space configuration including at least one of the following:
an associated control resource set used to configure a time/frequency control resource set in which to search for downlink control information,
time location of the one or more search spaces configured by periodicity and starting offset within the periodicity, or
a number of PDCCH candidates,
wherein the wireless terminal device monitors the PDCCH candidates on the i^{th} CC following the search space configuration for the i^{th} CC.

31. The method according to claim 21,
wherein the first scheduling command is transmitted on the i^{th} CC of the M CCs with Subcarrier Spacing (SCS) configuration u,
wherein a maximum number of monitored PDCCH candidates for the wireless terminal device per slot or per span for operation with Nᵢ+1 CCs is defined as Mᵤ, where Mᵤ is an integer larger than 0, and
wherein the Nᵢ+1 CCs include the i^{th} CC and the Nᵢ other CCs of the M CCs.

32. The method according to claim 21, further comprising:
receiving an indication of Pᵢ parameters (a₁, a₂, . . . , a_{P}) from the wireless access node to split a monitored PDCCH candidates budget for the second scheduling command for Pᵢ+1 CCs, where 0≤a₁+ . . . +aₖ+ . . . +a_{P}_{ᵢ}≤1, and k is an integer where 1≤k≤Pᵢ,
wherein the Pᵢ+1 CCs include the i^{th} CC and the Pᵢ other CCs of the M CCs,
wherein a maximum number of monitored PDCCH candidates for the wireless terminal device per slot or per span for operation with a k^{th} CC of the M CCs is defined as Mₖ=aₖ·Mₖ; and
the maximum number of monitored PDCCH candidates for the wireless terminal device per slot or per span for operation with a (P+1)^{th} CC of the M CCs is defined as M_{P+1}=Mᵤ−ΣᵢMᵢ, and
wherein Mᵤ is the monitored PDCCH candidates budget for the i^{th} CC.

33. The method according to claim 21,
wherein the first scheduling command is transmitted on the i^{th} CC with Subcarrier Spacing (SCS) configuration u,
wherein a maximum number of monitored non-overlapped Control Channel Elements (CCEs) candidates for the wireless terminal device per slot or per span for operation with Nᵢ+1 CCs is defined as Cᵤ, where Cᵤ is an integer larger than 0, and
wherein the Nᵢ+1 CCs include the i^{th} CC and the Nᵢ other CCs of the M CCs.

34. The method according to claim 21, further comprising:
receiving an indication of Pᵢ parameters (a₁, a₂, . . . , a_{P}_{ᵢ}) to the wireless terminal device to split a non-overlapped CCE budget for the second scheduling command for the Pᵢ+1 CCs, where 0≤aₖ≤1, 0≤a₁+ . . . +aₖ+ . . . +a_{P}_{ᵢ}≤1, and k is an integer where 1≤k≤Pᵢ,
wherein the Pᵢ+1 CCs include the i^{th} CC and the Pᵢ other CCs of the M CCs,
wherein a maximum number of non-overlapped CCEs for the wireless terminal device per slot or per span for operation with a k^{th} CC of the M CCs is defined as Cₖ=aₖ·Cᵤ; and
the maximum number of non-overlapped CCEs for the wireless terminal device per slot or per span for operation with a (P+1)^{th} CC of the M CCs is defined as M_{P+1}=Cᵤ−ΣₖCₖ,
wherein Cᵤ is the non-overlapped CCEs budget for the i^{th} CC.

35. The method according to claim 21,
wherein Control Channel Element (CCE) indexes for PDCCH candidates are determined based on a unified CC index, wherein the unified CC index is one of the following:
a CC index of a CC carrying a PDCCH;
a CC index configured by Radio Resource Configuration (RRC) signaling; or
a smallest CC index among a set of CCs that can be scheduled by the PDCCH monitored in the scheduling CC.

36. The method according to claim 21,
wherein Downlink Control Information (DCIs) with a same DCI format carried by the first scheduling command on the i^{th} CC are padded with zeros or ones at the end of each DCI to match a DCI bit length corresponding to a maximum DCI bit size of the DCI carried by the first scheduling command on the i^{th} CC.

37. The method according to claim 21,
wherein a reference Subcarrier Spacing (SCS) configuration u is defined according to one of the following:
the reference SCS configuration u is configured by Radio Resource Configuration (RRC) signaling;
a smallest SCS configuration u among all the M CCs is determined as the reference SCS configuration u;
a largest SCS configuration u among all the M CCs is determined as the reference SCS configuration u;
among all the M CCs configured, a SCS configuration of a CC in PCell is determined as the reference SCS configuration u; or
among all the M CCs configured to the UE, a SCS configuration of a CC with a smallest CC index is determined as the reference SCS configuration u.

38. The method according to one of claims 21 and 37,
wherein within a time duration of each slot of the reference SCS configuration u, only up to one CC is configured with PDCCH monitoring occasions.

39. The method according to one of claims 21 and 37, further comprising:
monitoring PDCCH on only up to X CCs with a smaller CC index of the M CCs, within a time duration of each slot of the reference SCS configuration u, where X is an integer number based on a capability of the wireless terminal device, and where 1≤X≤M.

40. The method according to one of claims 21 and 37, further comprising:
receiving, from the wireless access node, an indication of a periodic PDCCH monitoring pattern to the wireless terminal device which dictates a CC to monitor PDCCH based on the periodic PDCCH monitoring pattern,
wherein the periodic PDCCH monitoring pattern is indicated by a bit sequence with X bits, wherein X is an integer larger than 1,
wherein each ┌log 2(M)┐ bits of the periodic PDCCH monitoring pattern corresponds to a slot for a reference Subcarrier Spacing (SCS) configuration, and
wherein a value of each ┌log 2(M)┐ bits of the periodic PDCCH monitoring pattern indicates a target CC on which the wireless terminal device needs to monitor PDCCH.

41. An apparatus for wireless communication comprising a processor that is configured to carry out the method of any of claims 1 to 40.

42. A non-transitory computer readable medium having code stored thereon, the code when executed by a processor, causing the processor to implement the method recited in any of claims 1 to 40.
